(19) United States
(12) Patent Application Publication
(10) Pub. No.: US 2020/0051186 A1
(43) Pub. Date: Feb. 13, 2020

(54) REAL-TIME RENEWABLE ENERGY CREDITS

(71) Applicant: Drift Marketplace, Inc., Seattle, WA (US)

(72) Inventors: Mushfiqur Rahman Sarker, Seattle, WA (US); Herbert Alan Tilley, Issaquah, WA (US); Gregory William Robinson, Covington, WA (US)

(21) Appl. No.: 16/538,249

(22) Filed: Aug. 12, 2019

Related U.S. Application Data
(60) Provisional application No. 62/717,416, filed on Aug. 10, 2018.

(51) Int. Cl. G06Q 50/06; G06Q 20/38; G06Q 40/04; G06Q 30/00

(52) U.S. Cl. CPC G06Q 50/06; G06Q 30/018; G06Q 40/04; G06Q 20/389

(57) ABSTRACT

A system is provided for matching real-time renewable resource credits with energy loads. The system generates real-time renewable energy credits (“RECs”) in real time with one or more attributes. A real-time REC is evidence of production of a base amount of electricity with attributes that may include actual time of production, location of production, and power type. When a supplier generates a base amount of electricity using renewable energy, the supplier is issued a real-time REC indicating actual time and production location. A consumer may purchase the real-time REC from that supplier based on matching the consumer's consumption to the real-time REC, make a claim, and then retire the real-time REC. As a result of this matching of production and consumption based on actual time and location, suppliers of electricity generated using renewable energy may be incentivized to build renewable energy plants near consumers, resulting in less pollution and less loss of energy during transmission.

### CROSS-REFERENCE TO RELATED APPLICATION(S)

The present application claims the benefit of U.S. Provisional Application No. 62/717,416, filed Aug. 10, 2018, entitled “REAL-TIME RENEWABLE ENERGY CREDITS”. The foregoing application is incorporated herein by reference in its entirety.

### BACKGROUND

The electrical grid is a network of suppliers and consumers of energy. The electrical grid includes a transmission grid and a distribution grid. Suppliers of large amounts of energy (e.g., hydroelectric plants, nuclear plants, and solar and wind farms) supply high-voltage electrical power to the transmission grid for transmission to substations. The substations step down the high-voltage electrical power of the transmission grid to lower-voltage electrical power of the distribution grid. Consumers connect to the distribution grid to obtain their electrical power. Various suppliers such as city power plants, solar farms, and wind farms may also connect to the distribution grid to supply electrical power.

To incentivize the production of renewable energy (e.g., electricity generated via solar or wind), renewable energy credits (“RECs”) are issued to suppliers of renewable energy. A REC signifies that the supplier generated 1 MWh (i.e., megawatt-hour) of renewable energy. Each REC has a unique identification number registered with a certifying entity. RECs are tradable, non-tangible energy commodities that represent proof that electricity was generated from an eligible renewable energy source and was fed into the electrical grid.

A consumer (e.g., a large company) who wants to make a claim about its use of renewable energy can purchase RECs to support the claim. When a claim is made based on a REC (e.g., “We consumed 1 MWh of renewable energy”), the consumer is responsible for “retiring” the REC with the certifying authority so that no additional claim can be made. For example, a company in New York City can purchase a REC issued to a supplier in Texas who generated 1 MWh of electricity using solar power. The REC may be issued in August to the supplier. The company can purchase that REC in December and make a claim based on that REC about the electricity used by the company in February. Of course, the electricity consumed by the company in February could have been produced by a coal power plant near New York City. Indeed, the electricity generated by the supplier in August was consumed in August by a company in Texas. Thus, there is no correlation between the electricity produced as evidence by a REC and the electricity consumed that is the basis of a claim based on a REC.

Because there is no correlation between the electricity produced and consumed, many of the benefits of renewable energy cannot be realized. For example, although the company in New York City can make a claim based on a REC for electricity produced in Texas, the pollution level in New York City is not reduced because the company actually consumed electricity produced by the coal power plant. As another example, a supplier of energy may have no incentive to build a solar power plant near New York City because the cost of producing electricity near New York City is likely more than the cost of producing electricity in Texas and the price of RECs may be independent of the location of production of the electricity.

In addition, sometimes a purchaser of a REC may fraudulently make multiple claims about the REC without retiring the REC. Similarly, a purchaser who makes a claim based on a REC without retiring the REC may sell the REC to an unsuspecting purchaser who then also makes a claim based on that REC.

The bitcoin system was developed to allow electronic cash to be transferred directly from one party to another without going through a financial institution, as described in the white paper entitled “Bitcoin: A Peer-to-Peer Electronic Cash System” by Satoshi Nakamoto. A bitcoin (e.g., an electronic coin) is represented by a chain of transactions that transfers ownership from one party to another party. To transfer ownership of a bitcoin, a new transaction is generated and added to a stack of transactions in a block. The new transaction, which includes the public key of the new owner, is digitally signed by the owner with the owner's private key to transfer ownership to the new owner, as represented by the new owner public key. The signing by the owner of the bitcoin is an authorization by the owner to transfer ownership of the bitcoin to the new owner via the new transaction. Once the block is full, the block is “capped” with a block header that is a hash digest of all the transaction identifiers within the block. The block header is recorded as the first transaction in the next block in the chain, creating a mathematical hierarchy called a “blockchain.” To verify the current owner, the blockchain of transactions can be followed to verify each transaction from the first transaction to the last transaction. The new owner need only have the private key that matches the public key of the transaction that transferred the bitcoin. The blockchain creates a mathematical proof of ownership in an entity represented by a security identity (e.g., a public key), which in the case of the bitcoin system is pseudo-anonymous.

To ensure that a previous owner of a bitcoin did not double-spend the bitcoin (i.e., transfer ownership of the same bitcoin to two parties), the bitcoin system maintains a distributed ledger of transactions. With the distributed ledger, a ledger of all the transactions for a bitcoin is stored redundantly at multiple nodes (i.e., computers) of a blockchain network. The ledger at each node is stored as a blockchain. In a blockchain, the transactions are stored in the order that the transactions are received by the nodes. Each node in the blockchain network has a complete replica of the entire blockchain. The bitcoin system also implements techniques to ensure that each node will store the identical blockchain, even though nodes may receive transactions in different orderings. To verify that the transactions in a ledger stored at a node are correct, the blocks in the blockchain can be accessed from oldest to newest, generating a new hash of the block and comparing the new hash to the hash generated when the block was created. If the hashes are the same, then the transactions in the block are verified. The bitcoin system also implements techniques to ensure that it would be infeasible to change a transaction and regenerate the blockchain by employing a computationally expensive technique to generate a nonce that is added to the block when it is created. A bitcoin ledger is sometimes referred to as an Unspent Transaction Output (“UTXO”) set because it tracks the output of all transactions that have not yet been spent.

Although the bitcoin system has been very successful, it is limited to transactions in bitcoins or other cryptocurrencies. Efforts are currently underway to use blockchains to support transactions of any type, such as those relating to the sale of vehicles, sale of financial derivatives, sale of stock, payments on contracts, and so on. Such transactions use identity tokens, which are also referred to as digital bearer bonds, to uniquely identify something that can be owned or can own other things. An identity token for a physical or digital asset is generated using a cryptographic one-way hash of information that uniquely identifies the asset. Tokens also have an owner that uses an additional public/private key pair. The owner public key is set as the token owner identity, and when performing actions against tokens, ownership proof is established by providing a signature generated by the owner private key and validated against the public key listed as the owner of the token. A person can be uniquely identified, for example, using a combination of a user name, social security number, and biometric (e.g., fingerprint). A product (e.g., refrigerator) can be uniquely identified, for example, using the name of its manufacturer and its serial number. The identity tokens for each would be a cryptographic one-way hash of such combinations. The identity token for an entity (e.g., person or company) may be the public key of a public/private key pair, where the private key is held by the entity. Identity tokens can be used to identify people, institutions, commodities, contracts, computer code, equities, derivatives, bonds, insurance, loans, documents, and so on. Identity tokens can also be used to identify collections of assets. An identity token for a collection may be a cryptographic one-way hash of the digital tokens of the assets in the collection. The creation of an identity token for an asset in a blockchain establishes provenance of the asset, and the identity token can be used in transactions (e.g., buying, selling, insuring) involving the asset stored in a blockchain, creating a full audit trail of the transactions.

To record a simple transaction in a blockchain, each party and asset involved with the transaction needs an account that is identified by a digital token. For example, when one person wants to transfer a car to another person, the current owner and next owner create accounts, and the current owner also creates an account that is uniquely identified by the car's vehicle identification number. The account for the car identifies the current owner. The current owner creates a transaction against the account for the car that indicates that the transaction is a transfer of ownership, indicates the public keys (i.e., identity tokens) of the current owner and the next owner, and indicates the identity token of the car. The transaction is signed by the private key of the current owner, and the transaction is evidence that the next owner is now the current owner.

To enable more complex transactions than bitcoin can support, some systems use “smart contracts.” A smart contract is computer code that implements transactions of a contract. The computer code may be executed in a secure platform (e.g., an Ethereum platform, which provides a virtual machine) that supports recording transactions in blockchains. In addition, the smart contract itself is recorded as a transaction in the blockchain using an identity token that is a hash (i.e., identity token) of the computer code so that the computer code that is executed can be authenticated. When deployed, a constructor of the smart contract executes, initializing the smart contract and its state. The state of a smart contract is stored persistently in the blockchain. When a transaction is recorded against a smart contract, a message is sent to the smart contract, and the computer code of the smart contract executes to implement the transaction (e.g., debit a certain amount from the balance of an account). The computer code ensures that all the terms of the contract are complied with before the transaction is recorded in the blockchain. For example, a smart contract may support the sale of an asset. The inputs to a smart contract to sell a car may be the identity tokens of the seller, the buyer, and the car and the sale price in U.S. dollars. The computer code ensures that the seller is the current owner of the car and that the buyer has sufficient funds in their account. The computer code then records a transaction that transfers the ownership of the car to the buyer and a transaction that transfers the sale price from the buyer's account to the seller's account. If the seller's account is in U.S. dollars and the buyer's account is in Canadian dollars, the computer code may retrieve a currency exchange rate, determine how many Canadian dollars the seller's account should be debited, and record the exchange rate. If either transaction is not successful, neither transaction is recorded.

When a message is sent to a smart contract to record a transaction, the message is sent to each node that maintains a replica of the blockchain. Each node executes the computer code of the smart contract to implement the transaction. For example, if 100 nodes each maintain a replica of a blockchain, then the computer code executes at each of the 100 nodes. When a node completes execution of the computer code, the result of the transaction is recorded in the blockchain. The nodes employ a consensus algorithm to decide which transactions to keep and which transactions to discard. Although the execution of the computer code at each node helps ensure the authenticity of the blockchain, large amounts of computer resources are required to support such redundant execution of computer code.

Although blockchains can effectively store transactions, the large amount of computer resources, such as storage and computational power, needed to maintain all the replicas of the blockchain can be problematic. To overcome this problem, some systems for storing transactions do not use blockchains, but rather have each party to a transaction maintain its own copy of the transaction. One such system is the Corda system developed by R3, Ltd., which provides a decentralized distributed ledger platform in which each participant in the platform has a node (e.g., computer system) that maintains its portion of the distributed ledger. When parties agree on the terms of a transaction, a party submits the transaction to a notary, which is a trusted node, for notarization. The notary maintains a UTXO database of unspent transaction outputs. When a transaction is received, the notary checks the inputs to the transaction against the UTXO database to ensure that the outputs that the inputs reference have not been spent. If the inputs have not been spent, the notary updates the UTXO database to indicate that the referenced outputs have been spent, notarizes the transaction (e.g., by signing the transaction or a transaction identifier with a public key of the notary), and sends the notarization to the party that submitted the transaction for notarization. When the party receives the notarization, the party stores the notarization and provides the notarization to the counterparties.

### BRIEF DESCRIPTION OF THE DRAWINGS

FIG. 1 is a diagram that illustrates the real-time power generation and consumption of a residence equipped with a rooftop solar system in some embodiments.

FIG. 2 is a diagram that illustrates the matching of unmatched power generation to consumers.

FIG. 3 is a diagram that illustrates the time-based matching of solar power with a consumer who does not generate solar power.

FIG. 4 is a diagram that illustrates time-based matching of solar power with a consumer who does not generate solar power.

FIG. 5 is a diagram that illustrates power generation for different types of renewable energy.

FIG. 6 is a diagram that illustrates the matching of renewable energy with a commercial consumer.

FIG. 7 is a flow diagram that illustrates the processing of a component that matches real-time RECs to real-time ELs in some embodiments.

FIG. 8 is a block diagram that illustrates components of the real-time REC system in some embodiments.

FIG. 9 is a flow diagram that illustrates the processing of a receive production message component of a real-time REC smart contract in some embodiments.

FIG. 10 is a flow diagram that illustrates the processing of a create real-time REC component in some embodiments.

FIG. 11 is a flow diagram that illustrates the processing of a receive consumption message component of the real-time REC system in some embodiments.

FIG. 12 is a flow diagram that illustrates the processing of a create real-time EL component of the real-time REC system in some embodiments.

FIG. 13 is a flow diagram that illustrates the processing of a matching component of the real-time REC system in some embodiments.

FIG. 14 is a flow diagram that illustrates the processing of a receive bid request component of a consumer smart contract in some embodiments.

### DETAILED DESCRIPTION

Methods and systems are provided for matching real-time renewable resource credits with real-time energy loads. In some embodiments, a real-time REC system generates real-time renewable energy credits in real time with one or more attributes. A real-time REC is evidence of production of a base amount of electricity (e.g., 1 kWh) that is generated in real time with attributes that may include actual time of production (e.g., start time of production, such as 1:00 PM, and end time of production, such as 1:57 PM), location of production (e.g., Global Positioning System coordinates of wind farm), power type (e.g., solar, wind, or hydro), supplier of the electricity, and so on. When a supplier generates a base amount of electricity using renewable energy, the supplier is issued a real-time REC indicating actual time and location of production such as 12:00-1:06 PM on August 1 in New York City. A consumer in New York City who uses the base amount of electricity between 12:00 and 1:06 PM (referred to as an energy load) may want to claim that it consumed electricity produced by renewable energy at the same time and location. Such a consumer may purchase the real-time REC from that supplier (or third-party broker, retail energy company, and so on), make the claim, and then retire the real-time REC. As a result of this matching of production and consumption based on actual time and location, suppliers of electricity generated using renewable energy may be incentivized to build renewable energy plants near consumers, resulting in less pollution and less loss of energy during transmission. The real-time RECs are “real time” in the sense that are created in real time as the power is generated, in contrast to conventional RECs, which may be considered to be created offline sometime after the power is generated. The real-time REC system also overcomes problems of prior RECs in that the real-time REC system ensures that one real-time REC is not transferred to multiple consumers.

In some embodiments, the real-time REC system may employ a distributed ledger (such as a blockchain) to track production and consumption of electricity, control issuing of real-time RECs, match real-time RECs to real-time energy loads (“ELs”), trade real-time RECs, retire real-time RECs, and so on. Each supplier of electricity generated using renewable energy may have a production monitoring device that monitors production and, when the base amount of electricity is produced, effects the recording of a transaction in the blockchain as evidence of a real-time REC issued to the supplier. The production monitoring device may send a production message to an issuance smart contract recorded in the blockchain that is responsible for issuing real-time RECs and recording the real-time REC transactions in the blockchain. Each consumer of electricity who wants to consume electricity produced using renewable energy may have a consumption monitoring device that monitors consumption and, when the base amount of electricity is consumed, records a real-time EL in the blockchain as evidence of the consumption.

The real-time REC system may record a matching smart contract in the blockchain that is responsible for matching real-time RECs with real-time ELs based on their attributes such as time and location of production and consumption. The matching smart contract may execute on a periodic basis (e.g., upon receiving a message from an oracle) and match real-time RECs with real-time ELs. For example, the matching smart contract may execute once a day and, for each time slot (e.g., hour), match real-time RECs with real-time ELs with times during that time slot. The matching smart contract may employ an off-blockchain program that employs various optimization techniques to match real-time RECs to real-time ELs to, for example, minimize the overall differences in time of production and consumption and the overall distance between location of production and consumption. The off-blockchain program may employ an objective function that is based on several of the attributes of the real-time RECs and real-time ELs. Alternatively, the matching smart contract code may conduct an auction to match real-time RECs to real-time ELs. To conduct an auction, the matching smart contract code (or a corresponding off-blockchain program) may send bid request messages to bidding smart contracts of consumers to submit a bid to purchase that real-time REC to be matched with a real-time EL of a consumer. Once the bids for a real-time REC are received from the consumers, the matching smart contract code may select the real-time EL with the highest bid and match that real-time EL with the real-time REC by recording a transaction in the blockchain. The consumer of the real-time EL can then base a claim based on the real-time REC. Because a transaction matching the real-time REC with the real-time EL is recorded in the blockchain, that real-time REC cannot be matched to another real-time EL as the basis of a claim. This provides a technical solution to a problem of traditional RECs in that a supplier of a traditional REC could sell the same REC to multiple consumers, who could each make claims. The use of a distributed ledger by the real-time REC system provides indisputable proof of ownership and prevents the same real-time REC from being transferred to multiple owners (e.g., prevents it from being double-spent).

In some embodiments, each consumer may record a bidding smart contract in the blockchain to submit bids on behalf of that consumer. A bidding smart contract may have access to rules of the consumer for controlling the placing of bids. The rules may be recorded in the blockchain and updated periodically. The rules may, for example, base the bid amount on the difference between the time and location of a real-time REC and a real-time EL. Alternatively, the bidding smart contract for a consumer may employ off-blockchain code to generate bids for the consumer.

Many different countries and regions use renewable energy credits to incentivize production of renewable energy, although they may use different terminology to refer to REC-like concepts. For example, in the European Union the concept is referred to as Guarantee of Origin (“GO”), in Australia the concept is referred to as Large-scale Generation Certificate (“LGC”) and Small-scale Technology Certificate (“STC”), and in India the concept is referred to as the Renewable Purchase Obligation (“RPO”). The real-time REC system may be employed in these countries and regions and even in countries and regions that currently do not employ REC-like concepts.

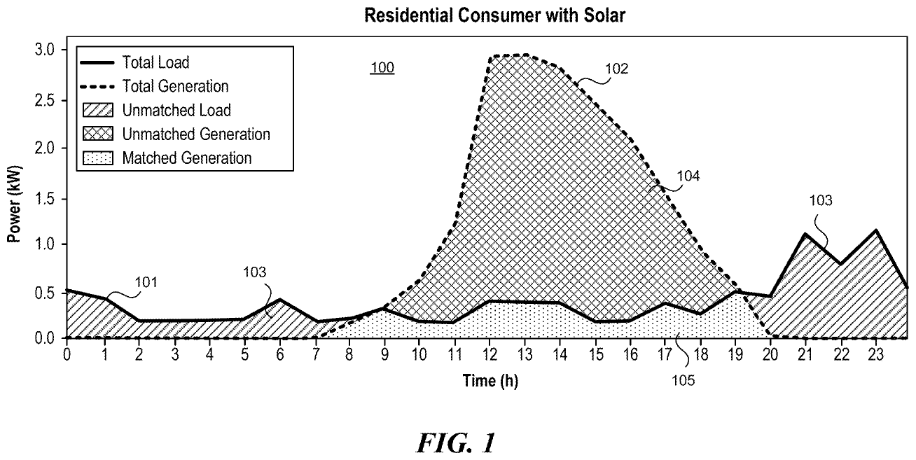

FIG. 1 is a diagram that illustrates the real-time power generation and consumption of a residence equipped with a rooftop solar system in some embodiments. At any given time interval, the solar system may generate more electricity than is consumed at the residence. Graph 100 includes an x-axis of hours (0-24) and a y-axis of power (kW). Line 101 represents the power consumed by the residence, and line 102 represents the power generated by the solar system. Area 103 represents the “unmatched consumption,” that is, power consumed in excess of power generated at the residence. Area 104 represents “unmatched generation,” that is, power generated in excess of consumption at the residence. Area 105 represents “matched generation,” that is, power generated but not consumed at the residence. The consumption monitoring device at the residence (or at the point at where the power enters the grid) directs that a real-time REC transaction be recorded in the blockchain each time a base amount of power is generated in excess of consumption.

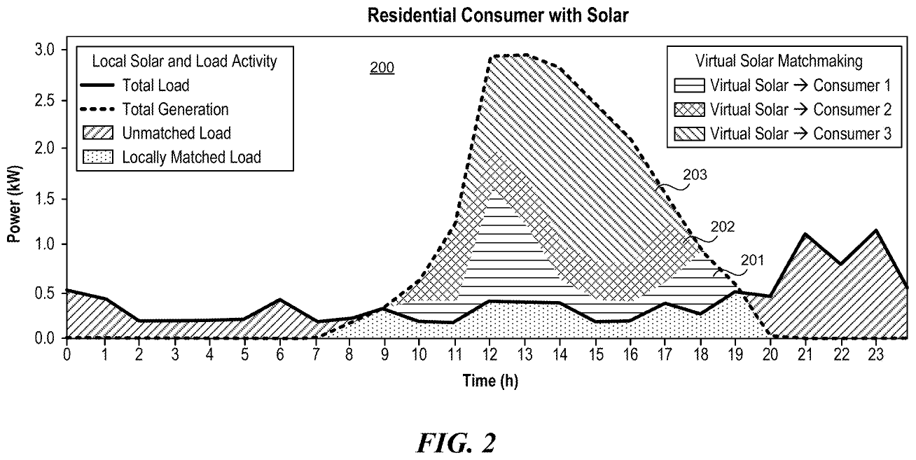

FIG. 2 is a diagram that illustrates the matching of unmatched power generation to consumers. Graph 200 illustrates the matching to consumers 1, 2, and 3. Areas 201, 202, and 203 are matched to consumers 1, 2, and 3, respectively. The consumption monitoring device of each consumer records a real-time EL transaction in the blockchain each time the consumer consumes the base amount of power in excess of consumption. The matching smart contract then matches the real-time RECs of the residence with the real-time ELs of the consumers, resulting in the matching illustrated by graph 200.

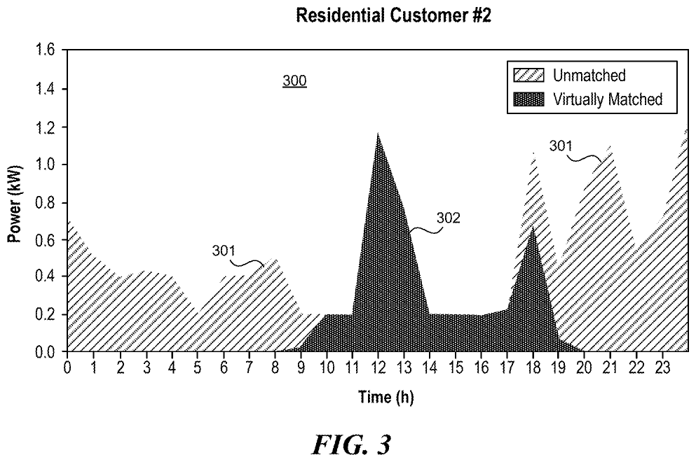

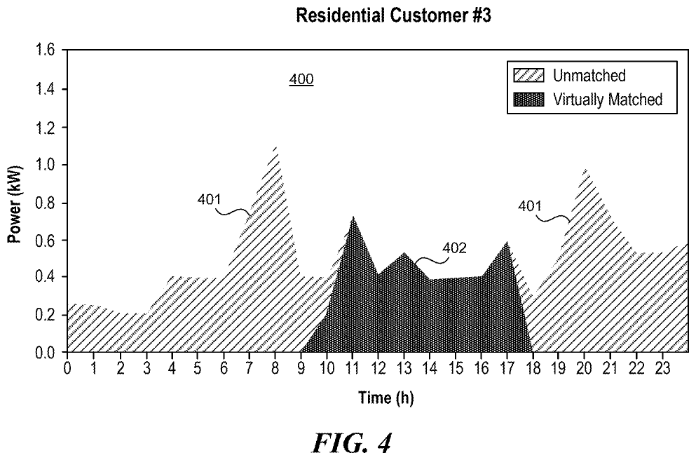

FIG. 3 is a diagram that illustrates the time-based matching of solar power with a consumer who does not generate solar power. Graph 300 illustrates the power consumed by the consumer. Area 301 represents power that is consumed during the nighttime, and thus the corresponding real-time ELs cannot be matched to real-time RECs representing solar power when time of day is a matching criterion. Area 302 represents power that is consumed during the daytime, and thus the corresponding real-time ELs can be matched to real-time RECs representing solar power. FIG. 4, like FIG. 3, is a diagram that illustrates time-based matching of solar power with a consumer who does not generate solar power.

Different renewable energy resources generate energy at different times of the day. For example, wind generation is high during the nighttime and low during the daytime. Solar generation exists only during the daytime and is nonexistent during the nighttime. Hydroelectric generation is constant throughout the day. When matching a real-time EL to a real-time REC based only on time, the real-time REC system matches based on times of generation and consumption irrespective of type of power. When matching based on both time and type of power, the real-time REC system matches based on both times of generation and consumption and types of power generated and specified by the consumer.

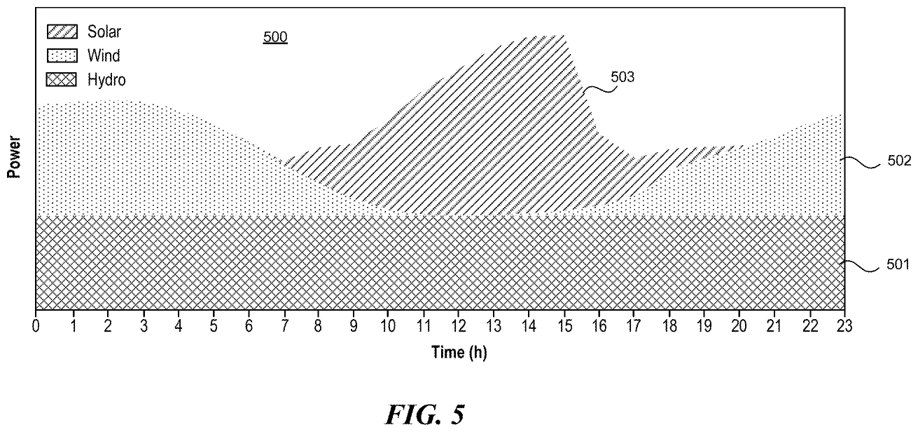

FIG. 5 is a diagram that illustrates power generation for different types of renewable energy. Graph 500 illustrates the power generated. Area 501 represents hydroelectric power, which is constant throughout the day. Area 502 represents wind power, which varies throughout the day. Area 503 represents solar power, which is only available during the daytime and varies throughout the day. The real-time RECs are recorded by the suppliers of the hydroelectric, wind, and solar energy, which are then matched with the real-time ELs recorded by consumers based on time of production and time of consumption.

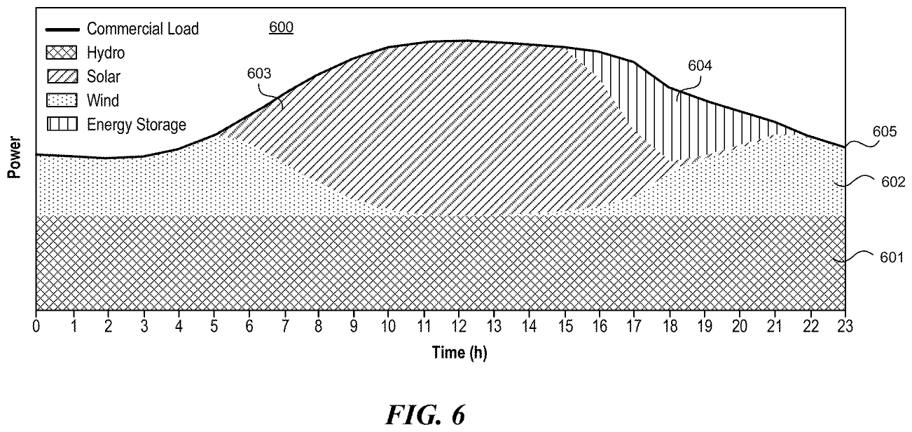

FIG. 6 is a diagram that illustrates the matching of renewable energy with a commercial consumer. Graph 600 illustrates the consumption and types of power to which the consumption is matched. Line 605 represents the energy consumed or load. Graph 500 (FIG. 5) illustrates the available power that is matched to the load of line 605. In this example, the supply 501-503 matches loads 601-603. Area 604 represents consumption that is unmatched by the generation of graph 500 during hours 15-22. The real-time REC system may match real-time RECs from energy storage charged by a renewable source to real-time ELs during hours 15-22. The real-time REC system may employ various algorithms when matching to real-time RECs from energy storage. For example, the real-time REC system may give preference to matching real-time RECs for non-storage sources over storage sources because the cost of storage sources can be much higher than the cost of non-storage. Nevertheless, the real-time REC system may match to storage sources to ensure that real-time EIs are matched to the extent possible 24/7/365.

The real-time REC system can interface with (e.g., via an application programming interface or client-side software) production and consumption devices to collect operational data at a relatively high rate such as periodically (e.g., hourly), when a base amount of energy is produced or consumed, or some other criteria is satisfied. The operational data may include generation measurements and load measurements. A real-time REC, whether recorded in a blockchain or in a conventional database, may contain:

Asset ID

Unique serial ID of real-time REC record

Start Time

End Time

Duration

Unit

Amount

Location

Value

Other Attributes

Once data is gathered via the metering/measurement technology, a record can be created using the above data points. Such records can then be used to match in real time to a load customer's usage records. The recording/accounting process can be implemented with relational databases or distributed ledgers.

The monitoring devices may interface with or be embedded in revenue-grade meters, smart meters, current transformers, inverters, smart Internet of Things (“IoT”) devices, and other devices. The production and consumption monitoring devices may be secure devices that execute software in a secure enclave such as the Software Guard eXtension (“SGX”) of Intel Corporation. The secure enclave (i.e., using a hardware private key) may attest to the software that is executing, and the executing software may use its private key for signing transactions recorded in the blockchain. Because the real-time REC system creates real-time RECs at a higher frequency than conventional RECs, real-time RECs provide a more granular accounting of energy production and consumption, which enables better matching of production to consumption.

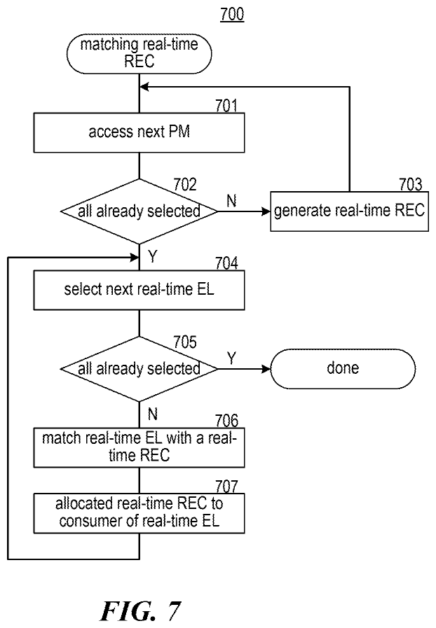

FIG. 7 is a flow diagram that illustrates the processing of a component that matches real-time RECs to real-time ELs in some embodiments. The component 700 accesses production messages and generates real-time RECs and matches them to real-time ELs. The component may be invoked periodically, such as once a day. In block 701, the component accesses the next production message generated by a supplier of electricity. In decision block 702, if all the production messages have already been selected, then the component continues at block 704, else the component continues at block 703. In block 703, the component generates a real-time REC corresponding to the accessed production message and continues to block 701. In block 704, the component selects the next real-time EL. In decision block 705, if all the real-time ELs have already been selected, then the component completes, else the component continues at block 706. In block 706, the component matches the selected real-time EL with a real-time REC. The determination as to whether a real-time EL matches a real-time REC may be based on matching criteria associated with the real-time EL. The matching criteria may be stored as metadata (e.g., as a transaction in a blockchain) for the real-time EL. The matching criteria may be based on certain variables such as type of renewable, time of day, location, and so on. The matching criteria may also specify a weight for the variables, such as a weight indicating a strong preference for solar power and a weight indicating generated in a wide geographic area surrounding the location. In block 707, the component allocates the matched real-time REC to the consumer of the real-time EL and loops to block 704 to select the next real-time EL.

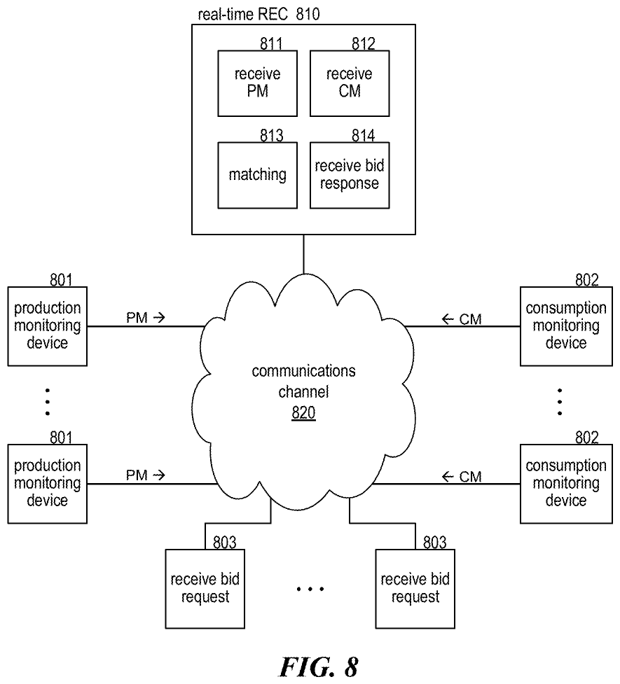

FIG. 8 is a block diagram that illustrates components of the real-time REC system in some embodiments. The real-time REC system includes production monitoring devices 801 of suppliers and consumption monitoring devices 802 of consumers. Each consumer may record a receive bid request component 803 of a smart contract in the blockchain. The real-time REC smart contract 810 may include a receive production message component 811, a receive consumption message component 812, a matching component 813, and a receive bid response component 814. The various devices and components may communicate via a communications channel 820.

The computing systems (e.g., network nodes or collections of network nodes) on which the real-time REC system may be implemented may include a central processing unit, input devices, output devices (e.g., display devices and speakers), storage devices (e.g., memory and disk drives), network interfaces, graphics processing units, cellular radio link interfaces, global positioning system devices, and so on. The input devices may include keyboards, pointing devices, touch screens, gesture recognition devices (e.g., for air gestures), head and eye tracking devices, microphones for voice recognition, and so on. The computing systems may include desktop computers, laptops, tablets, e-readers, personal digital assistants, smartphones, gaming devices, servers, and so on. The computing systems may access computer-readable media that include computer-readable storage media and data transmission media. The computer-readable storage media are tangible storage means that do not include a transitory, propagating signal. Examples of computer-readable storage media include memory such as primary memory, cache memory, and secondary memory (e.g., DVD) and other storage. The computer-readable storage media may have recorded on them or may be encoded with computer-executable instructions or logic that implements the real-time REC system. The data transmission media are used for transmitting data via transitory, propagating signals or carrier waves (e.g., electromagnetism) via a wired or wireless connection. The computing systems may include a secure cryptoprocessor as part of a central processing unit for generating and securely storing keys and for encrypting and decrypting data using the keys.

The real-time REC system may be described in the general context of computer-executable instructions, such as program modules and components, executed by one or more computers, processors, or other devices. Generally, program modules or components include routines, programs, objects, data structures, and so on that perform tasks or implement data types of the real-time REC system. Typically, the functionality of the program modules may be combined or distributed as desired in various examples. Aspects of the real-time REC system may be implemented in hardware using, for example, an application-specific integrated circuit (“ASIC”) or field programmable gate array (“FPGA”).

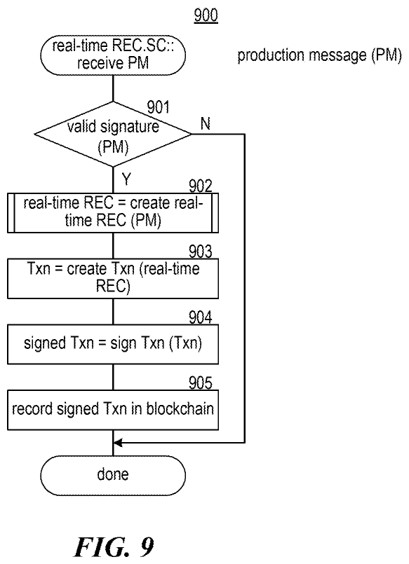

FIG. 9 is a flow diagram that illustrates the processing of a receive production message component of a real-time REC smart contract in some embodiments. The receive production message component 900 receives a production message from a supplier of renewable energy that includes attributes of the production. In decision block 901, if the signature on the production message is valid, that is, signed by the private key of the supplier, then the component continues at block 902, else the component completes. In block 902, the component invokes a create real-time REC component, passing an indication of the production message and receiving a real-time REC in response. In block 903, the component creates a transaction that includes the real-time REC. In block 904, the component signs the created transaction with the private key of a certifying authority. In block 905, the component records the signed transaction in the blockchain and then completes.

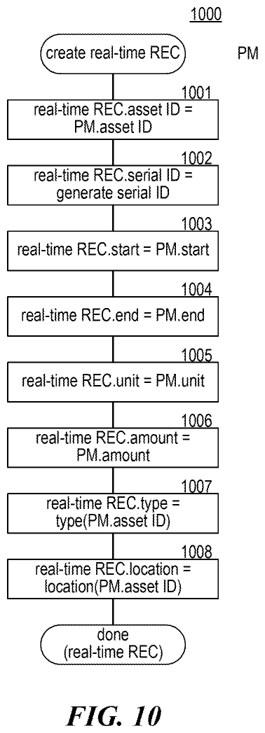

FIG. 10 is a flow diagram that illustrates the processing of a create real-time REC component in some embodiments. The create real-time REC component 1000 is passed a production message and creates a real-time REC by setting its attributes based on the production message. In block 1001, the component sets the asset ID to that of the asset (e.g., wind farm) that generated the base amount of electricity indicated by the production message. In block 1002, the component sets the serial number to a uniquely generated serial number. In blocks 1003-1006, the component sets various attributes of the real-time REC. In block 1007, the component sets the type (e.g., solar) based on the asset. In block 1008, the component sets the location based on the location of the asset. The component then completes with an indication of the real-time REC. In some embodiments, the component may use different sets of attributes (e.g., more, less, or different attributes).

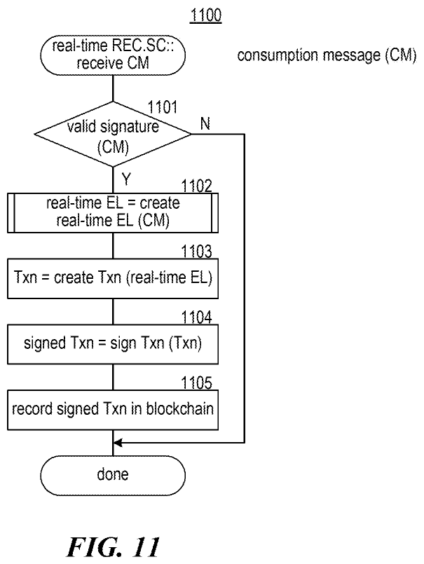

FIG. 11 is a flow diagram that illustrates the processing of a receive consumption message component of the real-time REC system in some embodiments. The receive consumption message component 1100 is provided a consumption message and generates and records a real-time EL. In decision block 1101, if the signature of the consumption message is valid, that is, signed by the consumer's private key, then the component continues at block 1102, else the component completes. In block 1102, the component invokes a create real-time EL component, passing the consumption message, to generate a real-time EL. In block 1103, the component creates a transaction that contains the real-time EL. In block 1104, the component signs the transaction. The transaction may need to be sent off-blockchain to be signed. In block 1105, the component records the signed transaction in the blockchain and then completes.

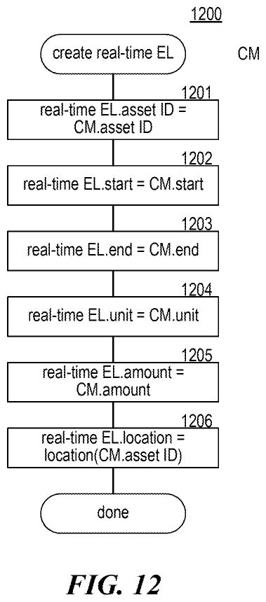

FIG. 12 is a flow diagram that illustrates the processing of a create real-time EL component of the real-time REC system in some embodiments. The create real-time EL component 1200 is provided a consumption message and generates a real-time EL. In block 1201, the component sets the asset ID. In blocks 1202-1206, the component sets other attributes of the real-time EL and then completes. In some embodiments, the component may use different sets of attributes (e.g., more, less, or different attributes).

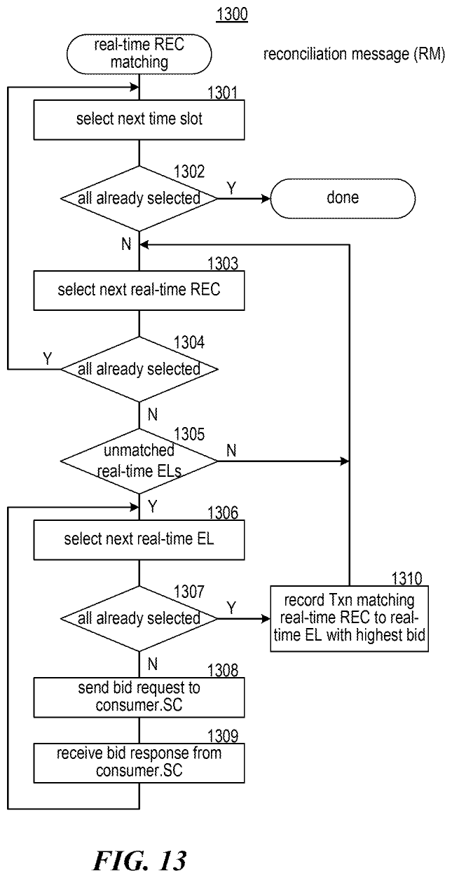

FIG. 13 is a flow diagram that illustrates the processing of a matching component of the real-time REC system in some embodiments. The matching component 1300 is provided a reconciliation message indicating that it is time to match or reconcile real-time RECs to real-time ELs. In block 1301, the component selects the next time slot. In decision block 1302, if all the time slots have already been selected, then the component completes, else the component continues at block 1303. In block 1303, the component selects the next real-time REC. In decision block 1304, if all the real-time RECs have already been selected, then the component loops to block 1301 to select the next time slot, else the component continues at block 1305. In decision block 1305, if there are unmatched real-time ELs, then the component continues at block 1306, else the component loops to block 1303 to select the next real-time REC. In block 1306, the component selects the next real-time EL. In decision block 1307, if all the real-time ELs have already been selected, then the component continues at block 1310, else the component continues at block 1308. In block 1308, the component sends a bid request to the smart contract of the consumer of the real-time EL. In block 1309, the component receives a bid response from the smart contract and then loops to block 1306 to select the next real-time EL. In block 1310, the component records a transaction in the blockchain matching the selected real-time REC to the real-time EL with the highest bid. The component then loops to block 1303 to select the next real-time REC.

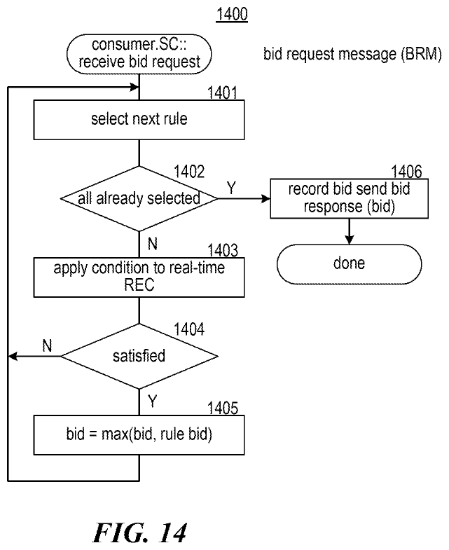

FIG. 14 is a flow diagram that illustrates the processing of a receive bid request component of a consumer smart contract in some embodiments. The receive bid request component 1400 is provided a bid request message that identifies a real-time REC and a real-time EL. In block 1401, the component selects the next matching rule of the consumer. In decision block 1402, if all the matching rules have already been selected, then the component continues at block 1406, else the component continues at block 1403. In block 1403, the component applies the condition of the selected rule to the real-time REC and the real-time EL. In decision block 1404, if the condition of the rule is satisfied, indicating that a bid can be placed to match the real-time REC to the real-time EL, then the component continues at block 1405, else the component loops to block 1401 to select the next rule. In block 1405, the component sets the bid to the maximum of the highest bid so far and the bid indicated by the rule and then loops to block 1401 to select the next rule. In block 1406, the component records a transaction indicating the bid in the blockchain and then sends a bid response message to the real-time REC smart contract and then completes.

The following paragraphs describe various embodiments of aspects of the real-time REC system. An implementation of the real-time REC system may employ any combination of the embodiments. The processing described below may be performed by a computing device with a processor that executes computer-executable instructions stored on a computer-readable storage medium that implements the real-time REC system.

In some embodiments, a method performed by a computing device matches real-time renewable energy credits with energy loads. Each real-time renewable energy credit is generated in real time and has one or more attributes. The method accesses production messages that each indicate production of renewable energy by a supplier. Each production message indicates time of production. For each production message, the method generates a real-time renewable energy credit with attributes indicating the supplier and time of the production. The method accesses real-time energy loads that each indicate consumption of energy by a consumer. Each real-time energy load is generated in real time and has attributes indicating the consumer and time of consumption. The method matches real-time renewable energy credits with real-time energy loads based on time of production and time of consumption. For each matched real-time renewable energy credit and real-time energy load, the method allocates that real-time renewable energy credit to the consumer of that real-time energy load. In some embodiments, the real-time renewable energy credits and the real-time energy loads are stored as transactions in a blockchain. In some embodiments, the matching and allocating are performed by a smart contract recorded in the blockchain. In some embodiments, the production messages are generated by devices of the suppliers. In some embodiments, the method further accesses consumption messages from consumers and generates a real-time energy load for each consumption message. In some embodiments, each real-time renewable energy credit includes an attribute indicating the location of production of renewable energy and each real-time energy load includes an attribute indicating the location of consumption of energy, and the matching is further based on location of production and location of consumption. In some embodiments, the matching is performed by conducting an auction in which consumers submit bids for matching their real-time energy loads to real-time renewable energy credits. In some embodiments, the matching is performed by applying an optimization technique that attempts to maximize the differences between prices at which suppliers are willing to sell real-time energy credits and prices that consumers are willing to pay for real-time energy credits. In some embodiments, the real-time renewable energy credits and the real-time energy loads are stored as records in a database that is not a distributed ledger.

In some embodiments, one or more computing systems for matching real-time renewable energy credits with energy loads are provided. The one or more computing systems comprise one or more computer-readable storage mediums for storing computer-executable instructions and one or more processors for executing the computer-executable instructions stored in the one or more computer-readable storage mediums. The instructions control the one or more computing systems to generate real-time renewable energy credits with attributes indicating the supplier and time of the production. The instructions control the one or more computing systems to match real-time renewable energy credits with real-time energy loads. Each real-time energy load has attributes indicating a consumer and time of consumption. The matching is based on time of production and time of consumption. For each matched real-time renewable energy credit and real-time energy load, the instructions control the one or more computing systems to allocate that real-time renewable energy credit to the consumer of that real-time energy load. In some embodiments, the real-time renewable energy credits and the real-time energy loads are stored as transactions in a blockchain. In some embodiments, the instructions for matching and allocating are instructions of a smart contract recorded in the blockchain. In some embodiments, the computer-executable instructions further control the one or more computing systems to receive production messages that are generated by devices of the suppliers, wherein a production message indicates the amount of production. Each real-time renewable energy credit has an amount of production. In some embodiments, the computer-executable instructions further control the one or more computing systems to receive consumption messages that are generated by devices of the consumers, wherein a consumption message indicates the amount of consumption. In some embodiments, the matching is further based on matching the amount of production with the amount of consumption. In some embodiments, the computer-executable instructions further control the one or more computing systems to access consumption messages from consumers and generate a real-time energy load for each consumption message. In some embodiments, each real-time renewable energy credit includes an attribute indicating the location of production of the renewable energy, each real-time energy load includes an attribute indicating the location of consumption of the energy, and the matching is further based on the location of production and the location of consumption. In some embodiments, the matching is performed by conducting an auction in which consumers submit bids for matching their real-time energy loads to real-time renewable energy credits. In some embodiments, the matching is performed by applying an optimization technique that attempts to maximize the differences between the prices at which suppliers are willing to sell real-time energy credits and the prices that consumers are willing to pay for real-time energy credits. In some embodiments, the real-time renewable energy credits and the real-time energy loads are stored as records in a database that is not a distributed ledger.

Although the subject matter has been described in language specific to structural features and/or acts, it is to be understood that the subject matter defined in the appended claims is not necessarily limited to the specific features or acts described above. Rather, the specific features and acts described above are disclosed as example forms of implementing the claims. For example, when trusted code of a node encrypts transactions for storage in the portion of the real-time REC stored at the node, the trusted code may use a symmetric key (i.e., that functions as both the encryption key and decryption key) rather than a public/private keypair. Accordingly, the invention is not limited except as by the appended claims.

I/We claim:

1. A method performed by a computing device for matching real-time renewable energy credits with real-time energy loads, each real-time renewable energy credit being generated in real time and having one or more attributes, the method comprising:
accessing production messages that each indicate production of renewable energy by a supplier, each production message indicating time of production;
for each production message, generating a real-time renewable energy credit with attributes indicating the supplier and time of the production;
accessing real-time energy loads that each indicate consumption of energy by a consumer, each real-time energy load being generated in real time and having attributes indicating the consumer and time of consumption;
matching real-time renewable energy credits with real-time energy loads based on time of production and time of consumption; and
for each matched real-time renewable energy credit and real-time energy load, allocating that real-time renewable energy credit to the consumer of that real-time energy load.

2. The method of claim 1 wherein the real-time renewable energy credits and the real-time energy loads are stored as transactions in a blockchain.

3. The method of claim 2 wherein the matching and allocating are performed by a smart contract recorded in the blockchain.

4. The method of claim 1 wherein the production messages are generated by devices of suppliers.

5. The method of claim 1 further comprising accessing consumption messages from consumers and generating a real-time energy load for each consumption message.

6. The method of claim 1 wherein each real-time renewable energy credit includes an attribute indicating location of production of renewable energy and each real-time energy load includes an attribute indicating location of consumption of energy and wherein the matching is further based on location of production and location of consumption.

7. The method of claim 1 wherein the matching is performed by conducting an auction in which consumers submit bids for matching their real-time energy loads to real-time renewable energy credits.

8. The method of claim 1 wherein the matching is performed by applying an optimization technique that attempts to maximize the differences between prices at which suppliers are willing to sell real-time energy credits and prices that consumers are willing to pay for real-time energy credits.

9. The method of claim 1 wherein the real-time renewable energy credits and the real-time energy loads are stored as records in a database that is not a distributed ledger.

10. One or more computing systems for matching real-time renewable energy credits with real-time energy loads, the one or more computing systems comprising:
one or more computer-readable storage mediums for storing computer-executable instructions for controlling the one or more computing systems to:
generate real-time renewable energy credits with attributes indicating a supplier and time of the production;
match real-time renewable energy credits with real-time energy loads, each real-time energy load having attributes indicating a consumer and time of consumption, the matching based on time of production and time of consumption; and
for each matched real-time renewable energy credit and real-time energy load, allocate that real-time renewable energy credit to the consumer of that real-time energy load; and
one or more processors for executing the computer-executable instructions stored in the one or more computer-readable storage mediums.

11. The one or more computing systems of claim 10 wherein the real-time renewable energy credits and the real-time energy loads are stored as transactions in a blockchain.

12. The one or more computing systems of claim 11 wherein the matching and allocating are performed by a smart contract recorded in the blockchain.

13. The one or more computing systems of claim 10 wherein the computer-executable instructions further control the one or more computing systems to receive production messages that are generated by devices of suppliers and wherein a production message indicates amount of production, each real-time renewable energy credit having an amount of production.

14. The one or more computing systems of claim 13 wherein the computer-executable instructions further control the one or more computing systems to receive consumption messages that are generated by devices of consumers and wherein a consumption message indicates amount of consumption.

15. The one or more computing systems of claim 14 wherein the matching is further based on matching amount of production with amount of consumption.

16. The one or more computing systems of claim 10 wherein the computer-executable instructions further control the one or more computing systems to access consumption messages from consumers and generate a real-time energy load for each consumption message.

17. The one or more computing systems of claim 10 wherein each real-time renewable energy credit includes an attribute indicating location of production of renewable energy and each real-time energy load includes an attribute indicating location of consumption of energy and wherein the matching is further based on location of production and location of consumption.

18. The one or more computing systems of claim 10 wherein the matching is performed by conducting an auction in which consumers submit bids for matching their real-time energy loads to real-time renewable energy credits.

19. The one or more computing systems of claim 10 wherein the matching is performed by applying an optimization technique that attempts to maximize the differences between prices at which suppliers are willing to sell real-time energy credits and prices that consumers are willing to pay for real-time energy credits.

20. The one or more computing systems of claim 10 wherein the real-time renewable energy credits and the real-time energy loads are stored as records in a database that is not a distributed ledger.
